(19) United States
(12) Patent Application Publication
(10) Pub. No.: US 2020/0283655 A1
(43) Pub. Date: Sep. 10, 2020

(54) COATING FORMULATION USING LOW-SUBSTITUTED CELLULOSE ETHER AND ITS PREPARATION

(71) Applicants: SE Tylose USA, Inc., Plaquemine, LA (US); Shin-Etsu Chemical Co., Ltd., Yokohama (JP)

(72) Inventors: Sakae Obara, Tokyo (JP); Anisul Quadir, East Setauket, NY (US)

(21) Appl. No.: 16/775,788

(22) Filed: Jan. 29, 2020

Related U.S. Application Data
(60) Provisional application No. 62/800,062, filed on Feb. 1, 2019.

(51) Int. Cl. C09D 101/28; C08B 11/20; C09D 7/63; B05D 3/12

(52) U.S. Cl. CPC C09D 101/284; B05D 3/12; C09D 7/63; C08B 11/20

(57) ABSTRACT

A coating composition is provided. The coating composition includes a wet-milled product obtained by applying a shear force to an aqueous suspension of low-substituted cellulose ether having a molar substitution of from 0.05 to 1.0 per anhydrous glucose unit. The aqueous suspension of low-substituted cellulose ether is obtained by suspending and dispersing the low-substituted cellulose ether in water and a short chain alcohol.

### RELATED APPLICATION

The following application claims priority to U.S. Provisional Application No. 62/800,062 filed Feb. 1, 2019, which is incorporated herein by reference in its entirety.

### FIELD OF THE INVENTION

The present invention relates to a composition for coating a solid preparation such as a tablet, a bead, and a granule. In particular, the present invention pertains to an improved coating composition that reduces the amount of time needed to coat a solid preparation.

### BACKGROUND OF THE INVENTION

It is already known in the industries such as pharmaceutical, health food and agrichemical industries that a film-forming composition is applied to solid preparations such as tablets and granules. It is applied in order to shield the solid preparations from light, prevent them from oxidation, adhesion and moisture, give them storage stability, sustain the release of a drug, or mask an unpleasant taste or odor.

Examples of the film-forming composition include cellulose derivatives such as water-soluble hydroxypropyl methyl cellulose, hydroxypropyl cellulose, hydroxyethyl cellulose, carboxymethyl cellulose, hydroxyethyl methyl cellulose and hydroxyethyl ethyl cellulose. The other examples include pullulan, carrageenan and polyvinyl alcohol. It is known that coating is carried out by applying an aqueous solution of such a film-forming composition to a preparation.

One example of a film-forming composition is described in U.S. Pat. No. 8,795,722 incorporated herein by reference in its entirety. The reference provides a water-swelling base material for forming a film having a desired water resistance and permitting high elution of a drug without the use of an organic solvent. Such formulation, however, tends to have a high viscosity.

Thus, there remains a need for lower viscosity formulations that result in reducing coating time without reducing the polymer concentration to eliminate the need for diluting the composition prior to application to a solid preparation.

### SUMMARY OF THE INVENTION

In one embodiment of the present invention, a composition is provided for coating a solid preparation comprising a wet-milled product obtained by applying a shear force to an aqueous dispersion of low-substituted cellulose ether having a molar substitution of from 0.05 to 1.0 per anhydrous glucose unit, wherein the aqueous suspension of low-substituted cellulose ether is obtained by suspending and dispersing the low-substituted cellulose ether in a mixture comprising water and a short chain alcohol.

In another embodiment, a method is provided for preparing a coating composition. The method comprises suspending a low-substituted cellulose ether having a molar substitution of from 0.05 to 1.0 per anhydrous glucose unit in water and a short chain alcohol to form an aqueous suspension, and applying a shear force to the aqueous suspension to obtain a wet-milled product suitable as a coating composition.

In yet another embodiment, a coated solid preparation obtained by applying the above-described film composition to a solid preparation containing a drug is provided. Coating a preparation with the composition of the present invention can provide a coated solid preparation permitting excellent elution of a drug, having a high masking effect of an unpleasant taste or the like of the drug, and providing an excellent feel upon ingestion without a sticky or slimy feel when the preparation is administered.

### DETAILED DESCRIPTION OF EMBODIMENTS OF THE INVENTION

The foregoing and other aspects of the present invention will now be described in more detail with respect to the description and methodologies provided herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items. Furthermore, the term “about,” as used herein when referring to a measurable value such as an amount of a compound, dose, time, temperature, and the like, is meant to encompass variations of 20 percent, 10 percent, 5 percent, 1 percent, 0.5 percent, or even 0.1 percent of the specified amount.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise defined, all terms, including technical and scientific terms used in the description, have the same meaning as commonly understood by one of ordinary skill in the art to which this invention belongs.

The term “consists essentially of” (and grammatical variants), as applied to in this invention, means the methods or compositions can contain additional steps or components as long as the additional steps or components do not materially alter the basic and novel characteristic(s) of the present invention.

The term “consisting of” excludes any additional step or component that is not specified in the claim.

Unless the context indicates otherwise, it is specifically intended that the various features of the invention described herein can be used in any combination.

Moreover, the present invention also contemplates that in some embodiments of the invention, any feature or combination of features set forth herein can be excluded or omitted.

All patents, patent applications and publications referred to herein are incorporated by reference in their entirety. In case of a conflict in terminology, the present specification is controlling.

As one of ordinary skill in the art may appreciate, the parameters described herein may vary greatly depending on the process, and/or formulation as well as the desired properties of the final product.

The present invention is directed to a coating composition and a method of preparing the composition. The composition comprises a wet-milled product obtained by applying a shear force to an aqueous suspension of low-substituted cellulose ether having a molar substitution of from 0.05 to 1.0 per anhydrous glucose unit. The aqueous suspension of low-substituted cellulose ether is obtained by suspending and dispersing the low-substituted cellulose ether in water and a short chain alcohol.

The composition for coating of the present invention can be prepared, for example, by wet-milling the low-substituted cellulose ether thus obtained. More specifically, a dispersion of the low-substituted cellulose ether can be obtained by suspending and dispersing it in a mixture comprising water and a short chain alcohol, wherein the short chain alcohol is included to reduce the viscosity of the composition without reducing the concentration of low-substituted cellulose ether. Subsequently, a shear force can be applied to the dispersion to cause self-collision of the low-substituted cellulose ether or cause collision of it with a collision plate. In the present invention, the dispersion of low-substituted cellulose ether prior to application of a shear force may be called “pre-shear dispersion”, while that after application of a shear force may be called “sheared dispersion.” Examples of compatible short chain alcohols may include ethanol, methanol, and 2-propanol.

The low-substituted cellulose ether of the present invention is water-insoluble and swells in water, and is soluble in an aqueous alkaline solution.

Celluloses are usually insoluble in water, but become soluble when the hydrogen atom of the hydroxyl group of the glucose ring of the celluloses is substituted with an alkyl or hydroxyalkyl group. The solubility depends on the substitution degree. Celluloses having a low degree of substitution are water-insoluble and swell in water, and are soluble in an aqueous alkaline solution.

Typical low-substituted cellulose ether to be used in the present invention can have a molar substitution of preferably from 0.05 to 1.0, more preferably from 0.1 to 0.8. The cellulose ether which is insoluble in water and produces a dispersion having high stability by application of a shear force may be used. When the molar substitution is less than 0.05, a stable dispersion may not be obtained by the application of a shear force. When the molar substitution is more than 1.0, water solubility of the cellulose ether may increase and masking of an unpleasant taste may be lowered. Examples of such low-substituted cellulose ether may include low-substituted alkyl cellulose such as low-substituted methyl cellulose and low-substituted ethyl cellulose, low-substituted hydroxyalkyl cellulose such as low-substituted hydroxyethyl cellulose and low-substituted hydroxypropyl cellulose, and low-substituted hydroxyalkyl alkyl cellulose such as low-substituted hydroxypropyl methyl cellulose, low-substituted hydroxyethyl methyl cellulose and low-substituted hydroxyethyl ethyl cellulose.

In one embodiment a low-substituted cellulose ether is used. An exemplary low-substituted hydroxypropyl cellulose is available as L-HPC from Shin-Etsu Chemical Co., Ltd. It is listed in the Japanese Pharmacopoeia, European Pharmacopoeia, and National Formulary, and generally incorporated as a disintegrant or binder in tablets or granules particularly in the field of pharmaceutical materials. The methods for preparing the low-substituted cellulose ether are known and described, for example, in Japanese Patent Application Examined Publication No. 57-53100/1982.

First, alkali cellulose can be prepared by immersing pulp, which is a starting material, in an aqueous alkaline solution such as sodium hydroxide; by mixing pulverized pulp with an alkaline solution; or by dispersing pulp powders in an organic solvent and then adding an alkali to the resulting dispersion.

The alkali cellulose thus obtained is then charged in a reactor and an etherifying agent such as propylene oxide or ethylene oxide is added therein. The resulting mixture may be heated for reaction to yield the corresponding cellulose ether.

After completion of the reaction, the resulting crude cellulose ether may be transferred to another tank, in which the alkali is neutralized with an acid. The resulting solid can be washed, dried and pulverized to yield a finished product in the powder form.

Alternately, it may be also obtained by dissolving the crude cellulose ether just after the reaction in water completely or partially, neutralizing the resultant, collecting the polymer thus precipitated, washing, drying and then pulverizing the polymer.

The sheared dispersion to be used for the composition for coating can be obtained, for example, by causing self-collision of the dispersed low-substituted cellulose ether or causing collision of it with a collision plate for milling it. An apparatus for preparing the sheared dispersion of low-substituted cellulose ether by causing self-collision of the low-substituted cellulose ether or causing collision of it with a collision plate for milling it may include, but not limited to, a vibratory ball mill, a colloid mill, a homomixer and a homogenizer. Specific examples of the colloid mill may include “Masscolloider” and “Cerendipitor” (trade names; products of Masuko Sangyo Co., Ltd.). Preferable examples of the homogenizer which can prepare a uniform dispersion may include “Homogenizer” (product of Sanwa Machine Co., Inc.) which is a high pressure homogenizer capable of spraying a treatment fluid through openings of a valve under high pressure and thereby causing collision and friction of the low-substituted cellulose ethers, “Ultimaizer System” (trade name; product of Sugino Machine Co., Ltd.), “Microfluidizer” (trade name; product of Microfluidics, MA, USA), “High pressure homogenizer” (product of Gaulin Co., Ltd.), and ultrasonic homogenizers utilizing oscillation of an ultrasonic wave and “Ultrasonic Homogenizer” (trade name; product of Nissei Corporation). A sheared dispersion which has been subjected to repeated treatments with such an apparatus can also be employed.

Further, a method for preparing the sheared dispersion of low-substituted cellulose ether may comprise dissolving the low-substituted cellulose ether in an aqueous alkaline solution (having an alkali concentration of typically from 2 to 25 percent by weight, especially from 3 to 15 percent by weight) and neutralizing the alkaline solution with an amount equivalent to that of the alkali of an organic acid such as acetic acid, formic acid or propionic acid, or of an inorganic acid such as hydrochloric acid or sulfuric acid, while shearing and milling the resulting alkaline solution in a colloid mill or causing collision and pulverization of the low-substituted cellulose ether in the homogenizer, as described in Japanese Patent Application Unexamined Publication No. 2002-204951.

When the sheared dispersion of low-substituted cellulose ether is prepared, it may be effective to spray the pre-shear dispersion of low-substituted cellulose ether from a pair of nozzles to cause them to collide each other or to spray the pre-shear dispersion of low-substituted cellulose ether from a nozzle to a collision plate for causing the dispersion to collide with a collision plate. During the collision, it may be desired to adjust the spray pressure of the pre-shear dispersion of low-substituted cellulose ether from the nozzle to from 60 to 250 MPa and the self-collision angle of the pre-shear dispersion of low-substituted cellulose ether or the collision angle of the pre-shear dispersion of low-substituted cellulose ether against a collision plate to from 90 to 180°, more preferably from 95 to 178°, still more preferably from 100 to 170°. The frequency of the collision may be preferably from 1 to 200 times, especially preferably from 5 to 120 times. The average particle size of the low-substituted cellulose ether may be reduced by the collision to preferably not greater than ¼, more preferably from ⅕ to 1/100, still preferably from ⅙ to 1/50, especially preferably from 1/7 to 1/20 of the average particle size of the low-substituted cellulose ether prior to collision. The average particle size can be determined by a photograph made through an optical microscope, a polarization microscope or a transmission electron microscope, or determined as an average of the lengths of at least 200 particles measured by an image analyzer. A sufficiently uniform dispersion of low-substituted cellulose ether cannot be obtained when the pressure, collision angle or collision frequency is outside the above-described range and in such a case, a remarkable reduction in the molecular weight of the low-substituted cellulose ether may occur.

When the low-substituted cellulose ether is dispersed with milling, it may be preferable to apply a shear force of from 500 sec-1 or greater, more preferably 1000 sec-1 or greater, still more preferably 1500 sec-1 or greater to the dispersion. The shear force may be applied repeatedly or continuously. It may be preferably applied preferably from 1 to 60 times, more preferably from 10 to 60 times in order to attain sufficient milling. When the shear force is applied less than once, the resulting low-substituted cellulose ether may have a deteriorated film forming property. When the shear force is applied more than 60 times, the polymerization of the low-substituted cellulose ether may decrease, leading to reduction in the film strength.

The dispersion of low-substituted cellulose ether thus obtained can have a concentration of preferably from about 3 to 20 percent by weight. When the concentration is less than 3 percent by weight, it takes long hours to obtain a desired coating weight when the low-substituted cellulose ether is used later for coating, which may lead to a decrease in the productivity. When the concentration is more than 20 percent by weight, the viscosity of the wet-milled product may increase excessively so that the delivery of it may be disturbed.

The low-substituted cellulose ether is suspended and dispersed in a mixture of water and a short chain alcohol to form the hydroalcoholic suspension. Within the suspension, water may be present at a concentration between about 10 to 50 percent by weight of the aqueous suspension, the low substituted cellulose ether may be present a concentration between about 3 to 20 percent by weight, and the remaining composition may be comprised of the short chain alcohol.

The average particle size of the low-substituted cellulose ether in the wet-milled product can be determined from a photograph made through an optical microscope, polarization microscope or transmission electron microscope, or determined by measuring lengths of at least 200 particles with an image analyzer. It may be preferably 20 μm or less, especially preferably 10 μm or less. When the average particle size is more than 20 μm, drying of the aqueous dispersion may produce a discontinuous film which is partially transparent or a film comprising deposition of powders. The film comprising deposition of powders has weak film strength at the time of drying and cannot keep its shape when wetted with water. The lower limit of the average particle size may be, but not limited to, approximately 1 μm.

It is conventionally known that the particle size in an aqueous dispersion of a water-insoluble polymer has an influence on the film-forming property after drying. This also applies to the milled product of the low-substituted cellulose ether. When the particle size in an aqueous dispersion is smaller, the closer packing may be attained when the dispersion is dried. This causes coalescence of adjacent particles, facilitating the formation of a transparent continuous film.

The continuous transparent film has high strength at the time of drying, is insoluble in water, and swells with absorbed water. Such properties are considered to contribute masking of an unpleasant taste. The low-substituted cellulose ether has been used as a disintegrant because of the property of swelling with adsorbed water. Compared with the other water-insoluble film such as ethyl cellulose or acrylic resin film, the low-substituted cellulose ether film absorbs much water and disintegrates by swelling after certain hours. Thus, this film is considered to have a property for smoothly releasing a drug.

The coating composition may further include one or more additives. For example, additives may be included to facilitate film-formation or adjust solubility. Examples of possible additives include plasticizers, adhesion preventive agents, fillers, binders and lubricants/glidants.

A plasticizer such as glycerin, propylene glycol, polyethylene glycol, triethyl citrate, or mono-, di- or tri-acetin may be optionally added to the coating composition of the present invention. It may be especially preferred that at least one substance selected from the group consisting of glycerin, propylene glycol and polyethylene glycol is added. Addition of the plasticizer may be effective for improving the film-forming property and improving the flexibility of the resulting film. The amount of the plasticizer may be preferably from about 5 to 50 percent by weight based on the amount of the low-substituted cellulose ether. When the amount is less than 5 percent by weight, a film having flexibility may not be obtained. When the amount is more than 50 percent by weight, the water resistance of the resulting film may be lowered.

Further, an adhesion preventive agent such as talc and silica may be added. A cellulose derivative including hydroxypropyl methyl cellulose, hydroxypropyl cellulose, hydroxyethyl cellulose, carboxymethyl cellulose, hydroxyethyl methyl cellulose and hydroxyethyl ethyl cellulose, pullulan, carrageenan, polyvinyl alcohol, sugar or sugar alcohol can be added for adjusting the solubility.

Suitable fillers include lactose, lactose monohydrate, lactitol, saccharose, sorbitol, mannitol, dextrates, dextrins, dextrose, maltodextrin, croscarmellose sodium, silicified microcrystalline cellulose, microcrystalline cellulose, hydroxypropylcellulose, low-substituted hydroxypropylcellulose, hydroxypropylmethylcellulose polymers, hydroxyethylcellulose, sodium carboxymethylcellulose, carboxymethylene, carboxymethyl hydroxyethylcellulose and other cellulose derivatives, starches or modified starches (including potato starch, corn starch, maize starch and rice starch) and mixtures thereof.

Suitable binders include polyvinyl pyrrolidone (also known as povidone), polyethylene glycol(s), acacia, alginic acid, agar, calcium carrageenan, cellulose derivatives such as ethyl cellulose, methyl cellulose, hydroxypropyl cellulose, hydroxypropyl methyl cellulose, sodium carboxymethylcellulose, dextrin, gelatin, gum arabic, guar gum, tragacanth, sodium alginate, or mixtures thereof or any other suitable binder.

Suitable lubricants/glidants include stearic acid and pharmaceutically acceptable salts or esters thereof (for example, magnesium stearate, calcium stearate, sodium stearyl fumarate or other metallic stearates), talc, microcrystalline waxes, glycerides, light mineral oil, polyethylene glycol, silica acid and pharmaceutically acceptable salts or esters thereof (for example, silicates, silicon dioxide, colloidal silicon dioxide, sucrose esters of fatty acids, hydrogenated vegetable oils (for example, hydrogenated castor oil), or mixtures thereof.

The concentration of the low-substituted cellulose ether in the coating composition of the present invention may be preferably from about 3 to 20 percent by weight. When the amount is less than 3 percent by weight, it may take long hours to obtain a desired coating amount, leading to a reduction in productivity. When the amount is more than 20 percent by weight, the viscosity of the wet-milled product may become too high to deliver the coating composition. The amount of water in the coating composition may be from about 10 to 50 percent by weight, and the amount of short chain alcohol may be added such that the total weight of the combination of water, low-substituted cellulose ether and any other additives (including plasticizers and surfactants) is equal to 100 percent. Examples of the solid preparation to be used for coating may include tablets, granules, fine granules, powders and pills.

A coater may include, but not limited to, a draft coating pan, a fluid bed granulating coater, a rolling fluid-bed coater, and a high-speed agitation granulator. The coating can be carried out under conventional operation conditions.

The coating may be typically carried out by simultaneously spraying a coating solution and drying in a coater. In this case, further drying can be conducted in the coater after completion of the coating if necessary.

The present invention is suited for drugs having a particularly unpleasant taste or stimulating the oral cavity. Examples of such drugs may include, but not limited to, ibuprofen, dicrofenac sodium, acetylsalicylic acid, parasetamol, cimetidine, carboxymethylcysteine, tiopronin, dextromethorphan hydrobromide, codeine and salts thereof, buflomedil, morphine and salts thereof, 5-aminosalicylic acid, penicillin and derivatives thereof, erythromycin and derivatives thereof, cephalosporin, tetracycline, and crude drugs such as Ginkgo biloba extract.

The coating weight of the low-substituted cellulose ether may vary, depending on its preparation form. The coating weight of the low-substituted cellulose ether may be preferably from about 1 to 30 parts by weight, especially preferably from 1 to 10 parts by weight based on 100 parts by weight of an uncoated solid preparation. When the coating weight is less than 1 part by weight, the intended masking of taste may not be achieved. When the coating weight is more than 30 parts by weight, the elution of a drug may be lowered.

The present invention will hereinafter be described in more detail based on the Examples below. However, it should not be construed that the present invention is limited to or by the Examples.

### EXAMPLES

Comparison of Coating Formulations with and without a Short-Chain Alcohol

### Example A

| | |
|---|---|
| Low-substituted Hydroxypropyl | 10 w/w percent |
| Cellulose (type LH-21) | |
| Water | 36 w/w percent |
| Ethanol | 54 w/w percent |

### Comparative Example

| | |
|---|---|
| Low-substituted Hydroypropyl | 4 w/w percent |
| Cellulose (type LH-21) | |
| Water | 96 w/w percent |

The suspension of Example A was passed through Microfluidizer M110P with a pressure of 30000 psi for 3 times. The suspension became a viscous paste. This paste was diluted with mixture of water/ethanol (4:6 w/w). The maximum concentration of L-HPC that was able to spray for coating process was 6 percent, which is the limit of viscosity to spray.

The suspension of the Comparative Example was passed through Microfluidizer M110P (available from Microfluidics Corp.) with a pressure of 30000 psi for 3 times. The suspension became a viscous paste. This paste was diluted with water so that it can be sprayed for coating process. The maximum concentration of low-substituted hydroxypropyl cellulose that was able to spray for coating process was 3 percent, which is the limit of viscosity to spray. The concentration of Example A is twice of that of the Comparative Example, and the formulation of Example A can reduce the coating time to half of the Comparative Example.

Having thus described certain embodiments of the present invention, it is to be understood that the invention defined by the appended claims is not to be limited by particular details set forth in the above description as many apparent variations thereof are possible without departing from the spirit or scope thereof as hereinafter claimed.

1. A coating composition, comprising a wet-milled product obtained by applying a shear force to an aqueous suspension of low-substituted cellulose ether having a molar substitution of from 0.05 to 1.0 per anhydrous glucose unit, wherein the aqueous suspension of low-substituted cellulose ether is obtained by suspending and dispersing the low-substituted cellulose ether in water and a short chain alcohol.

2. The coating composition according to claim 1, wherein the short chain alcohol is selected from the group consisting of methanol, ethanol, and 2-propanol.

3. The coating composition according to claim 1, wherein the low-substituted cellulose ether is selected from the group consisting of hydroxypropyl methyl cellulose, hydroxypropyl cellulose, hydroxyethyl cellulose, carboxymethyl cellulose, hydroxyethyl methyl cellulose and hydroxyethyl ethyl cellulose.

4. The coating composition according to claim 1, wherein the aqueous suspension of low-substituted cellulose ether is comprised of between about 3 and about 20 percent by weight of low-substituted cellulose ether, between about 10 to about 50 percent by weight of water, and a remaining percent by weight of the short chain alcohol.

5. The coating composition according to claim 1, further comprising at least one plasticizer selected from the group consisting of glycerin, propylene glycol and polyethylene glycol.

6. The coating composition according to claim 1, further comprising a surfactant selected from the group consisting of a non-ionic detergent and an ionic detergent.

7. The coating composition according to claim 1, wherein applying the shear force to the aqueous suspension of low-substituted cellulose ether comprises causing self-collision of the low-substituted cellulose ether contained in the aqueous dispersion or causing collision of the low-substituted ether with a collision plate by a vibratory ball mill, colloid mill, homomixer or homogenizer for milling the low-substituted cellulose ether.

8. The coating composition according to claim 1, wherein applying the shear force to the aqueous suspension of low-substituted cellulose ether comprises spraying the aqueous suspension of low-substituted cellulose ether from a nozzle at a high pressure of from 60 to 250 MPa for causing self-collision of the aqueous suspensions of low-substituted cellulose ether.

9. The coating composition according to claim 1, wherein applying the shear force to the aqueous suspension of low-substituted cellulose ether comprises applying a shear rate of 500 sec-1 or greater to the aqueous suspension of low-substituted cellulose ether from 1 to 60 times for milling and dispersing the low-substituted cellulose ether.

10. A method of preparing a coating composition, comprising
suspending a low-substituted cellulose ether having a molar substitution of from 0.05 to 1.0 per anhydrous glucose unit in water and a short chain alcohol to form an aqueous suspension, and
applying a shear force to the aqueous suspension to obtain a wet-milled product.

11. The method according to claim 10, wherein the short chain alcohol is selected from the group consisting of methanol, ethanol, and 2-propanol.

12. The method according to claim 10, wherein the low-substituted cellulose ether is selected from the group consisting of hydroxypropyl methyl cellulose, hydroxypropyl cellulose, hydroxyethyl cellulose, carboxymethyl cellulose, hydroxyethyl methyl cellulose and hydroxyethyl ethyl cellulose.

13. The method according to claim 10, wherein the aqueous suspension of low-substituted cellulose ether is comprised of between about 3 and about 20 percent by weight of low-substituted cellulose ether, between about 10 to about 50 percent by weight of water, and a remaining percent by weight of the short chain alcohol.

14. The method according to claim 10, wherein applying the shear force to the aqueous suspension of low-substituted cellulose ether comprises causing self-collision of the low-substituted cellulose ether contained in the aqueous dispersion or causing collision of the low-substituted ether with a collision plate by a vibratory ball mill, colloid mill, homomixer or homogenizer for milling the low-substituted cellulose ether.

15. The method according to claim 10, wherein applying the shear force to the aqueous suspension of low-substituted cellulose ether comprises spraying the aqueous suspension of low-substituted cellulose ether from a nozzle at a high pressure of from 60 to 250 MPa for causing self-collision of the aqueous suspensions of low-substituted cellulose ether.

16. The method according to claim 10, wherein applying the shear force to the aqueous suspension of low-substituted cellulose ether comprises applying a shear rate of 500 sec-1 or greater to the aqueous suspension of low-substituted cellulose ether from 1 to 60 times for milling and dispersing the low-substituted cellulose ether.
